(19) United States
(12) Patent Application Publication
(10) Pub. No.: US 2007/0297621 A1
(43) Pub. Date: Dec. 27, 2007

(54) Robot Having a Head with Artificial Ears

(75) Inventor: Frank Joublin, Mainhausen (DE)

Correspondence Address: FENWICK & WEST LLP, SILICON VALLEY CENTER, 801 CALIFORNIA STREET, MOUNTAIN VIEW, CA, 94041, US

(73) Assignee: HONDA RESEARCH INSTITUTE EUROPE GMBH, Offenbach/Main (DE)

(21) Appl. No.: 11/765,965

(22) Filed: Jun. 20, 2007

(30) Foreign Application Priority Data
Jun. 22, 2006 (EP) 06012898

(51) Int. Cl. H04R 1/10; H04R 25/00

(52) U.S. Cl. 381/74; 381/384; 901/50

(57) ABSTRACT

An artificial ear for a robot comprises an auricle-shaped structure, a microphone which in a concha region of the auricle-shaped structure, wherein the lower or rear edge of the auricle-shaped structure forms acoustic shield for shadowing noise from any noise source located below or behind the concha region.

### RELATED APPLICATIONS

This application is related to and claims priority to European Patent Application No. 06 012 898 filed on Jun. 22, 2006, entitled “Robot Having a Head with Artificial Ears.” This application is also related to a U.S. patent application Ser. No. ______ filed on Jun. 20, 2007 (attorney docket number 12767) entitled “Robot Head with Artificial Ears.”

### FIELD OF THE INVENTION

The present invention relates to a method and system for sensing acoustic signal using an artificial ear for a robot including at least a microphone and a sound-guiding element.

### BACKGROUND OF THE INVENTION

Humanoid robots have internal noise sources that generate noises. The noises from fans and other mechanical components of the humanoid robots become interference to the binaural stereo microphones installed on the robots. The interference noise often causes inaccurate results in operations using acoustic signals such as sound localization where the location of sound source is estimated from the acoustic signals received by the binaural stereo microphones. Because of such noises, processing based on binaural stereo microphones in the humanoid robots may be less accurate than desired.

### SUMMARY OF THE INVENTION

One embodiment of the present invention provides an artificial ear for a robot head including an auricle-shaped structure, and a microphone that is placed in a concha region of the auricle-shaped structure. The concha region is a hollow region which is defined in the auricle-shaped structure. The microphone is placed at the bottom of the concha region that is open to the outside of the artificial ear.

In one embodiment of the present invention, the lower or the rear edge of the auricle-shaped structure functions as acoustic shields for shadowing noises that originate from noise sources located below or behind the hollow concha region. These acoustic shields may be formed by folding an outer edge portion of the auricle-shaped structure.

In one embodiment of the present invention, the acoustic shield produces a shielding or shadowing effect of at least 20 dB for components of the noises having frequencies above 2 kHz.

In one embodiment of the present invention, the microphone is functionally connected to a pre-amplifying circuitry that can be arranged at the back of the auricle-shaped structure. The pre-amplifying circuitry may be housed in a casing that extends to the back of the auricle-shaped structure.

In one embodiment of the present invention, the artificial ear is essentially circular in shape when seen from the side of the robot head.

In one embodiment of the present invention, the artificial ear includes an acoustically transparent cover that covers at least the upper front region of the artificial ear. The acoustic transparent cover may be removable from other parts of the artificial ear.

In one embodiment of the present invention, at least a lower rear edge portion of the auricle-shaped structure can be covered by an acoustically shadowing cover. The acoustically shadowing cover is formed by folding an edge portion integrated to and extending from the auricle-shaped structure.

In one embodiment of the present invention, the artificial ear is used in humanoid robots, wherein an auricle-shaped structure includes an acoustically transparent cover and an acoustically shadowing cover. The line separating the acoustically transparent cover and the acoustically shadowing cover may be “S” shaped or an inverted “S” shaped to provide a good shadowing effect against typical noise sources (e.g., a fan) in the humanoid robots. The shape of the separation line also enhances signals coming from sound sources in front of the humanoid robots.

In one embodiment of the present invention, the line separating the acoustically transparent cover and the acoustically shadowing cover includes a convex segment directly connected to a concave segment.

In one embodiment of the present invention, a robot head is provided with a pair of binaural artificial ears, one artificial ear at each side (left and right) of the robot head.

In one embodiment of the present invention, the two ears are mechanically connected by an earphone-like bending element so that the artificial ears can be removed easily from the robot head.

In one embodiment of the present invention, the robot head includes at least one camera at its front face.

In one embodiment of the present invention, the humanoid robots are equipped with the artificial ears or robot head.

In one embodiment of the present invention, the robot is provided with a fan for cooling electrical circuitry in the robot, the fan being arranged under and/or behind the artificial ear(s).

In one embodiment of the present invention, the fan is integrated at a backpack of the robot.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the present invention can be readily understood by considering the following detailed description in conjunction with the accompanying drawings.

FIG. 1 illustrates a perspective view of an artificial ear, according to one embodiment of the present invention.

FIG. 2 illustrates a side view of an artificial ear with acoustically transparent cover, according to one embodiment of the present invention.

FIG. 3 illustrates a humanoid robot with an artificial ear, according to one embodiment of the present invention.

FIG. 4 illustrates a robot head according to one embodiment of the present invention.

### DETAILED DESCRIPTION OF THE INVENTION

A preferred embodiment of the present invention is now described with reference to the figures where like reference numbers indicate identical or functionally similar elements.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

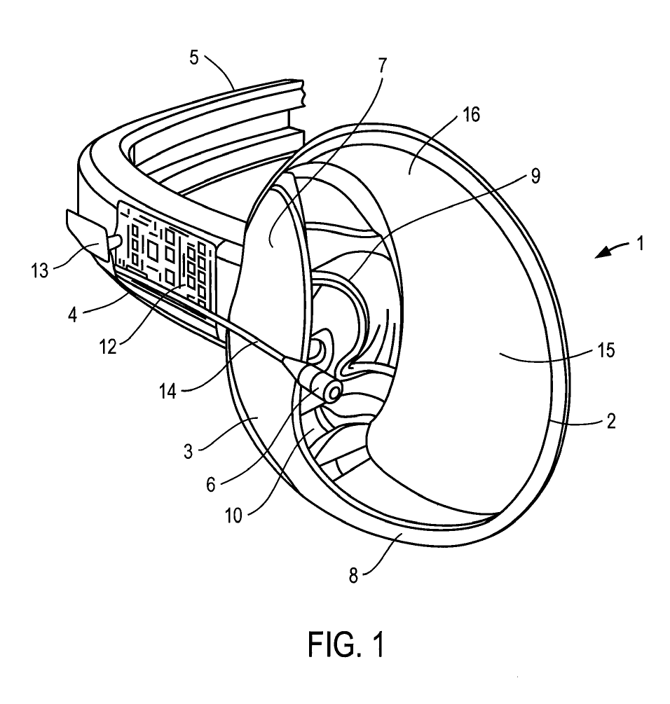

FIG. 1 illustrates a perspective view of an artificial ear 1, according to one embodiment of the present invention. The embodiment of FIG. 1 does not provide a replica of the human ear, but provides an artificial ear adapted for use with a robot, especially a robot with a head.

In the embodiment of FIG. 1, the artificial ear 1 includes a circular ground base plate 2. An auricle-shaped structure 3 extends outside the base plate 2. At the rear end of the auricle-shaped member 3, an extension 4 is integrated to the base plate 2. The extension 4 contains electrical circuitry 12 such as pre-amplifying circuits. The electrical circuitry 12 is provided with an interface 13 in order to transmit the pre-processed electrical signals to a computing unit of a robot. The computing unit can then determine target subjects for the robot based on the processed signals, for example, by estimating sound localization. In one embodiment, the robot then moves its head to face the estimated location of the sound source or moves to the estimated location of the sound source.

The longitudinal extension 4 may include an elastic and bendable mechanical connection member 5 that can be used for electrically connecting the artificial ear 1 to a second artificial ear 1′ arranged at the opposite side of the robot head.

The auricle-shaped structure 3 of the artificial ear 1 defines a hollow concha region 18. A microphone 6 is placed at the bottom of the concha region 10 where the sound converges. The hollow concha region 10 can be in a shape of an asymmetrical cone enhancing acoustic signals coming from a sound source in front of the robot head. It is important to make the concha region 10 and adjacent regions asymmetric to obtain localization cues in the elevation plane.

The microphone 6 communicates signals with the processing circuitry 12 via a functional connection 14.

The rear end and/or the lower end of the auricle-shaped structure 3 can include acoustic shields 7, 8. The acoustic shields 7, 8 are designed to shield or shadow the noises originating from noise sources at the back of the artificial ear 1 or below the artificial ear 1.

In one embodiment of the present invention, the acoustic shields 7, 8 may be formed by folding an outer edge integrated with the auricle-shaped structure 3.

The rear acoustic shield 7 covers the concha region 10 at least in a partially overlapping manner to shield or shadow the artificial ear 1 efficiently against noises generated by typical noise sources located at the back of the artificial ear 1.

On the other hand, the width of the lower acoustic shield 8 can be made much smaller than the width of the rear acoustic shield 7 such that the area the lower acoustic shield overlaps with the base plate 2 is much smaller than the area the rear acoustic shield 7 overlaps with the base plate 2.

The front region 15 and the upper region 16 of the artificial ear 1 may be (acoustically) completely exposed. That is, any sound originating from a sound source above or in front (to the right side of FIG. 1) of the artificial ear 1 can enter the hollow concha region 10 and then to the microphone 6 without obstructions.

In one embodiment of the present invention, inner pinnae elements 9 are provided in the concha region 10. The inner pinnae elements 9 introduce asymmetry to sound signals coming from above the artificial ear 1 and below the artificial ear 1.

The inner pinnae elements 9 are designed to enhance 3D localization cues and enhance front signals. The asymmetry introduced by the inner pinnae elements 9, and the amplification of front source signals contribute to a better separation of Interaural Level Differences (ILD) cues from the front and the back, respectively.

The acoustic shields 7, 8 of the artificial ear 1 are useful in robots with noise sources. For example, the noise source may be a fan arranged below or at the back of the artificial ear 1.

The acoustic shields 7, 8, and the inner pinnae elements 9 also allow the artificial ear 1 to selectively receive signals from a sound source in front of the robot that is located slightly higher than the artificial ear 1. Therefore, the artificial ear 1 of the embodiment in FIG. 1 is particularly useful for use on the head of the humanoid robot that is designed to interact with humans, but shorter than humans.

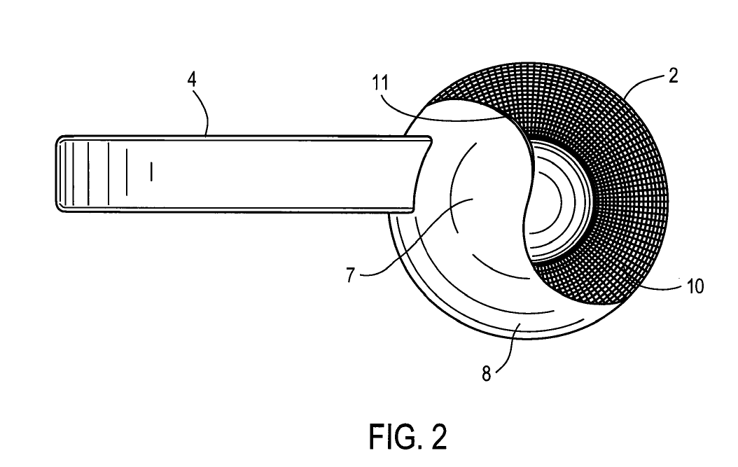

FIG. 2 illustrates a side view of the artificial ear 1 with an acoustically transparent cover 2, according to one embodiment of the present invention. The basic contour is defined by a symmetrical base plate 2. In one embodiment, the upper and front parts of the artificial ear 1 are covered by an acoustically transparent and optionally replaceable cover 10. The acoustically transparent cover 10 can be made from a porous or grid-like material.

In one embodiment, a line 11 separating the acoustically transparent cover 10 and the acoustic shields 7, 8 are “S” shaped or inverted “S” shaped. Specifically, the separating line 11 between the acoustically transparent cover 10 and the acoustic shields 7, 8 is a combination of a convex segment and a concave segment.

This division between the overlapping acoustic shields 7, 8 (an extension of the folded outer edge of the auricle-shaped structure 3) and the acoustically transparent cover 10 is particularly adapted for the heads of robots, especially robots shorter or having approximately the same height as an adult human (i.e., 160 cm or smaller), and designed to communicate with humans through sounds (e.g., through voice recognition).

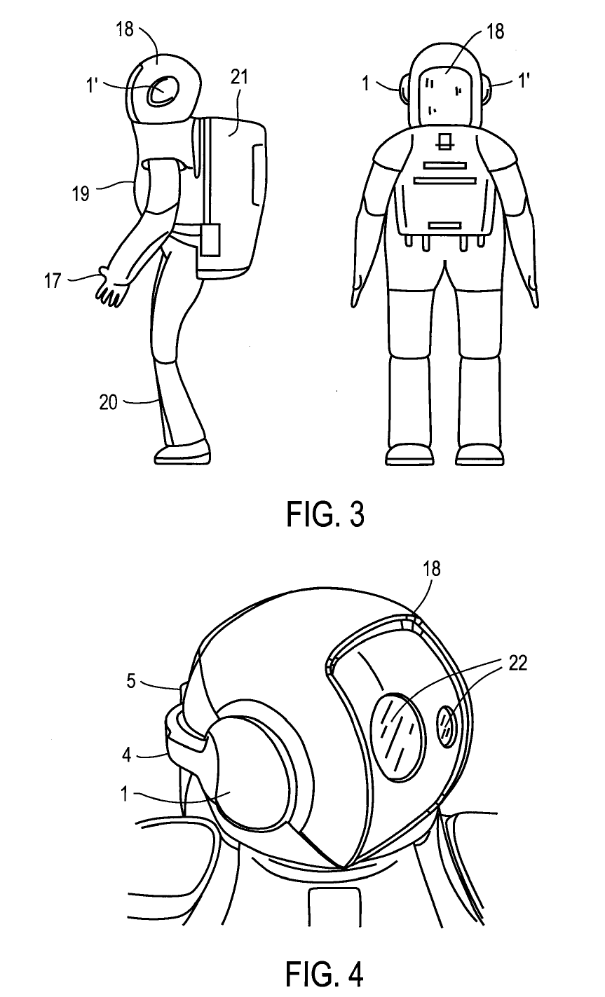

FIG. 3 illustrates a humanoid robot, according to one embodiment of the present invention. In one embodiment of the present invention, The humanoid robot, for example, is Honda's ASIMO robot that is a biped humanoid robot with two arms 17, a head 18 with two cameras 22 at the front (refer to FIG. 4), a body 19, two legs 20, and a backpack 21 containing computer hardware. The backpack can also contain a cooling fan that becomes a noise source. The artificial ears 1, 1′ at the sides the head 18 of the humanoid robot should be shielded from the noise generated by the noise source.

Note that the embodiments of the present invention can be used in connection with any static or moveable robot head. The “head” generally refers to a structure supporting the artificial ears that are separated by a certain distance. The term “head” is used herein to refer to any structure that can support the artificial ears.

In one embodiment, the robot includes only a head and does not include other moving parts. In another embodiment, the robot comprises other moving parts that support the head and perform motions such as walking or rolling.

FIG. 4 is a diagram illustrating the head 18 of a robot with the two cameras 22 at its front. In one embodiment, the artificial ears 1, 1′ are connected to each other by an elastic and bendable mechanical connection member 5 shaped like an earphone-like unit that can be removed from the head 18.

In another embodiment, the auricle-shaped structure 3 of the artificial ears 1, 1′ can be an integrated to the head 18.

In the embodiment of FIG. 4, the artificial ears 1, 1′ are mounted on the head 18 of the robot so that the two microphones 6 of the artificial ears 1, 1′ are separated by some distance. Such separation of the microphones 6 allows determination of Interaural Time Differences (ITD) that can be used for localizing the location of the sound within a so-called cone of confusion. In one embodiment, the head 18 between the microphones 6 is configured to have a shadowing effect on the sound level in order to improve the ILD.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. An artificial ear for a robot, comprising:
an auricle-shaped structure defining a concha region, the auricle-shaped structure comprising an acoustic shield; and
a microphone placed in the concha region of the auricle-shaped structure, the acoustic shield shielding the microphone from noises generated by a noise source located below or behind the concha region.

2. The artificial ear of claim 1, wherein the acoustic shield is configured to provide a shielding effect of at least 20 dB for components of the noises having frequencies above 2 kHz.

3. The artificial ear of claim 1, further comprising pre-amplifying circuitry at behind the auricle-shaped structure, the pre-amplifying circuitry coupled to the microphone.

4. The artificial ear of claim 3, further comprising a casing extending rearward from the auricle-shaped structure for containing the pre-amplifying circuitry.

5. The artificial ear of claim 1, wherein the artificial ear is circular shaped.

6. The artificial ear of claim 1, further comprising an acoustically transparent cover coving at least an upper front portion of the artificial ear.

7. The artificial ear of claim 6, wherein the acoustically transparent cover is removable from other parts of the artificial ear.

8. The artificial ear of claim 6, further comprising an acoustically shadowing cover covering at least a lower rear portion of the artificial ear.

9. The artificial ear of claim 1, wherein the auricle-shaped structure comprises inner pinnae elements in the concha region, the pinnae elements introducing acoustic asymmetry between first sounds from a first sound source located above the artificial ear and second sounds from a second sound source located below the artificial ear.

10. The artificial ear of claim 1, wherein the acoustic shield is formed by folding an outer edge portion of the auricle-shaped structure.

11. An artificial ear, comprising:
an auricle-shaped structure defining a concha region, the auricle-shaped structure covered by an acoustically transparent cover and an acoustically shadowing cover, an line separating the transparent cover and the acoustically shadowing cover forming an S-shaped line or an inverted S-shaped line; and
a microphone placed in the concha region of the auricle-shaped structure.

12. An artificial ear, comprising:
an auricle-shaped structure defining a concha region, the auricle-shaped structure covered by an acoustically transparent cover and an acoustically shadowing cover, a line separating the transparent cover and the acoustically shadowing cover comprising a convex line coupled to a concaved line; and
a microphone placed in the concha region of the auricle-shaped structure.

13. A robot head including two artificial ears, each artificial ear comprising:
an auricle-shaped structure defining a concha region, the auricle-shaped structure comprising an acoustic shield; and
a microphone placed in the auricle-shaped structure at the concha region, the acoustic shield shielding the microphone from noises generated by a noise source located below or behind the concha region.

14. The robot head of claim 13, wherein the two artificial ears are provided at opposite sides of the head.

15. The robot head of claim 14, wherein the two artificial ears are mechanical connected by an earphone-like bending element.

16. The robot head of claim 14, further comprising at least one camera at front of the robot head.

17. A robot comprising:
at least one artificial ear, each artificial ear comprising:
an auricle-shaped structure defining a concha region, the auricle-shaped structure comprising acoustic shields; and
a microphone placed in the concha region of the auricle-shaped structure, the acoustic shields shielding the microphone from noises generated by a noise source located below or behind the concha region.

18. The robot of claim 17, wherein the noise source is a fan for cooling electrical circuitry, the fan located behind or under the artificial ears.

19. The robot of claim 18, wherein the fan is integrated in a computing backpack of the robot.
